(19) United States
(12) Patent Application Publication
(10) Pub. No.: US 2011/0179697 A1
(43) Pub. Date: Jul. 28, 2011

(54) Method for Production of Metallocenes Preventing Nitrogen Oxides Emission in Combustion of Fuels in Motors

(75) Inventors: ALIMAMED L. SHABANOV, BAKU (AZ); ELMIRA M. RAMAZANOVA, BAKU (AZ)

(73) Assignee: ASIACOM GROUP INVESTMENTS, INC.

(21) Appl. No.: 12/694,686

(22) Filed: Jan. 27, 2010

(51) Int. Cl. C10L 1/30; C07F 17/02; B01F 1/00

(52) U.S. Cl. 44/361; 556/143; 252/364

(57) ABSTRACT

A method of making ferrocene and other metallocenes involves adding a metal halide, such as iron chloride (FeCl₃), to a solution of diethylamine, cyclopentadiene, a crown ether, and a metal (Fe° powder, Na° or K°). After stirring the boiling mixture, the diethylamine is removed, and the residue extracted with a hydrocarbon condensate. The extract is filtered and vacuum stripped to crystallize the metallocene, such as ferrocene from the solution. The method provides an improved process for producing organometallic compounds containing a transition element as the metal component. The method also provides an improved process for the production of bis(cyclopentadienil) transition element compounds marked by economy of operation and good yields. The resulting products have been shown to increase octane ratings and reduce NOₓ emissions in motor fuels.

### BACKGROUND

This disclosure relates to a method of making cyclopentadien-metal compounds, also known as metallocenes, such as those of iron, titanium, zirconium, hafnium, vanadium, chromium, molybdenum, tungsten, manganese, iron, ruthenium, osmium, cobalt, rhodium, or nickel and in particular to a process for the production of ferrocene from a mixture of iron (II) chloride, diethilamine and cyclopentadiene. This disclosure also relates to use of such metallocenes to reduce nitrogen oxide emissions of internal combustion engines.

Ferrocene (bis-cyclopentadienyl iron, with the chemical formula Fe(C5H5)₂) is an organometallic compound having the structure:

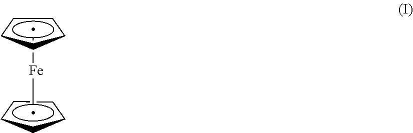

Ferrocene has numerous uses, including use as a gasoline antiknock additive (in place of tetraethyl lead), in ammonia synthesis reactions, and in fertilizer production. As a fuel catalyst for rocket propellants, ferrocene may improve combustion speed and lower the temperature of exhaust pipes. When added to fuel oils, ferrocene can help reduce smoke and air pollution, increase power and increase fuel economy. Ferrocene also has application in such diverse areas as integrated circuit manufacture, plastics stabilization, photography and printing, and biochemistry and medicine. Ferrocene, and other metallocenes, also have use in reducing nitrogen oxide emissions of internal combustion engines.

Prior processes for producing ferrocene have often not been economically viable. For instance, one prior process (see U.S. Pat. No. 3,217,022) involves dissolving ferric chloride in methanol and adding iron powder. Sodium methylate and then cyclopentadien are added, and ferrocene ultimately precipitates out of the solution. This method involves large amounts of methanol, difficult purification steps to remove by-products of the process, and only results in reported yields of 65-70%.

Another method, described at http://www.orgsyn.org/orgsyn/orgsyn/prepContent.asp?prep=cv4p0473, mixes cyclopentadien with iron chloride, diethylamine, and tetrahydrofuran. This method takes several hours of vigorous stirring. This method also involves large amounts of solvent and significant and difficult preparatory treatments, such as peroxide removal and drying.

Still another prior process involves a two step process using tetrahydrofuran to form ferric chloride, FeCl₂, followed by reaction of the FeCl₂ with sodium cyclopentadien under a nitrogen atmosphere. Ferrocene is then extracted using petroleum ether. This process typically takes several hours, and requires use of sodium and tetrahydrofuran.

Another method is disclosed by U.S. Pat. No. 7,157,592 to Ramazanova et al. According to that method, ferrocene is produced from a mixture of relatively expensive ferrous chloride, cyclopentadien, diethylamine, and dibenzo-18-crown-6-potassium complex, with further petroleum ether extraction of the prepared product. That method has advantages, but one disadvantage is the expense of the FeCl₂.

Unfortunately, these prior processes have often involved long reaction times, expensive and dangerous reagents, relatively low yields, an inability to scale to production quantities of ferrocene, and other problems. Thus, an improved method of producing ferrocene is desirable, particularly one that may also be useful in preparing other cyclopentadien-metal compounds in addition to ferrocene.

### SUMMARY

This application discloses a method of making ferrocene and other metallocenes that overcomes these and other problems of the previous methods. According to the present method, metallocenes are synthesized from ferric chloride, metals (iron, Na° or K°), diethylamine and cyclopentadiene. Various crown ethers such as 15-crown-5,18-crown-6, dibenzo-18-crown-6 or dicyclohexene-18-crown-6 and crown ethers containing nitrogen atoms in the macrocyclic ring catalyze the reaction.

In particular, according to this method, iron chloride (FeCl₃) is added to a solution of diethylamine, cyclopentadiene, the crown ether, and a metal (Fe° powder, Na° or K°). After stirring the mixture for 2 hours while boiling, the diethylamine is removed, and the residue is extracted with a hydrocarbon condensate. The extract is filtered and vacuum stripped to crystallize ferrocene from the solution. The method provides an improved process for producing organometallic compounds containing a transition element as the metal component. The method also provides an improved process for the production of bis(cyclopentadienil) transition element compounds marked by economy of operation and good yields. The method also allows industrial production of metallocenes.

### DETAILED DESCRIPTION

According to the present method, cyclopentadiene reacts with iron (III) and cobalt (III) halide in the presence of an organic amine, with a crown ether as a catalyst. An alkali metal promotes this process. First, crown compounds react with alkali metal giving nanometal complex II [A. L. Shabanov et al. Russian J. Org. Chem. 2009, #1, pp. 26-29. © Pleiades Publishing Ltd. 2009. Dye J. and ets. All. J. Am. Chem. Soc. 1970, vol. 92. p. 526]. The mechanism may be illustrated as:

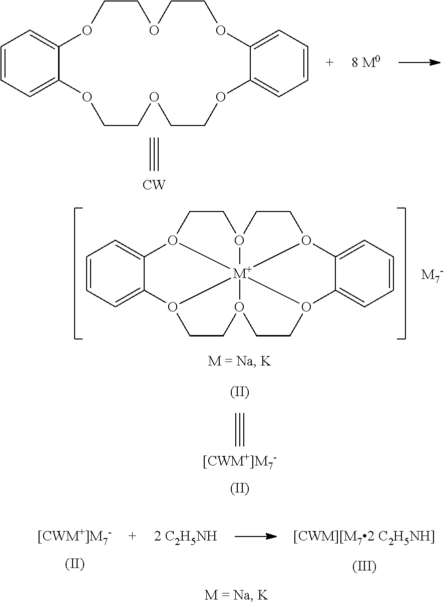

The catalytic action of the nanometal-crown compound complex II depends on the high basity of the dialkylamine-nanometalcrown ether associate III, prepared thanks to electron transfer from nanocomplex II to antibonding molecular orbitals of dialkylamine. Due to its high basity the intermediate associate III catalyzes direct metallocene production from ferric halide (FeCl₃), cyclopentadien and diethylamine using an acid-base mechanism:

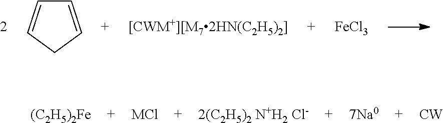

This method also can be used in direct production of cobaltocenes from CoCl₃.

The catalytic action of the crown (CW)-alkali metal complex (II) not only reduces the time of reaction, but also eliminates the need for expensive solvents such as tetrahydrofurane, thereby reducing the costs of the metallocene production. The reaction appears generally applicable to halides of transition elements. If ferric chloride is substituted for ferrous chloride, the reaction is modified to the extent of utilization of one mole of cyclopentadiene to two moles of Fe(III) (or other metal).

Amines are important components in forming metallocenes according to the present method. Amines in this method function to capture the hydrogen halide as it forms. Therefore the basicity of the amines is very important. Generally, the higher basicity constant (log Kₐ) values of the amines, the higher yield is obtained, although other factors such as the solubility of the particular amine-transition element complex in the reaction medium may mask or counteract this tendency. Amines with log Kₐ>10 are presently preferred for obtaining a higher yield. Examples of satisfactory amines include diethylamine, n-butylamine, ethylenediamine, ethylamine, benzylamine, triethylamine and 1,6-hexanediamine. These amines have properties useful to form complexes with a transition metal halide. One preferred amine for use in this method is diethylamine. Its basicity is relatively high (log Kₐ=10.96), it has a relatively low boiling point and it is generally a good solvent for anhydrous transition element halides.

The present method is carried out by first mixing the amine, crown ether catalyst and alkali metal with the transition metal halide to form a crown ether-alkali metal-amine complex (III), before addition of cyclopentadiene. The reaction takes place over a fairly wide temperature range. At temperatures approaching the boiling point of the solution, the reaction is sufficiently rapid and the yield is satisfactory high. At lower temperatures the reaction rate decreases.

The ratio of reactants may vary over wide values. Typically, a mole ratio of cyclopentadiene to metal halide of at least 2:1 is employed. The mole ratio of crown ether to transition metal halide may also vary over wide values, but maintaining that ratio between 0.005:1 appears to work well. The mole ratio of alkali metal to crown ether is typically 1:0.005 or greater. The duration of the reaction may vary over wide limits and in any particular instance strongly depends on temperature, the particular reactants, their ratio and similar factors. An extended duration of reaction has not been found deleterious. A reaction time of 1-4 hours has been found satisfactory.

The gas condensate fraction that is used for extraction is a technical product having a boiling point of about 35-60° C. This gas condensate product typically contains low molecule weight aliphatic hydrocarbons such as pentane and its isomers and hexane and its isomers. Experimental data indicates that the gas condensate fraction is a highly selective extragent for the separation of ferrocene from the reaction mixture. The gas condensate fraction is also much cheaper than petroleum ether. Ferrocene is very soluble in this gas condensate fraction, and the fraction may also be recovered and re-used.

A distinct feature and advantage of the present method is simplicity and low cost. The amine salts may be reconverted into the initial amine and may be reused in the process again and again. The formed solid diethylamine hydrochloride may be separated by filtration from the product and reacts under molten conditions with powdered iron according the scheme:

2(C₂H₅)₂NH.HCl+Fe→FeCl₂+2(C₂H₅)₂NH+H₂

Under these conditions, the amine vaporizes and may be separated from the hydrogen, which also may be captured and reused. The amine may alternatively be recovered by reaction with an inorganic base (NaOH or Ca(OH)₂) according the scheme:

2(C₂H₅)₂NH.HCl+Ca(OH)₂→CaCl₂+2(C₂H₅)₂NH+H₂O

The method thus presents significant potential for economical use of materials. The reconversion of the amine also results in the formation of FeCl₂ by reduction, something that has been experimentally confirmed, although at the present the mechanism is not certain.

Another curious property of the present method is the formation of a K₇ nanoparticle see Shabanov, Russian Journal of Organic Chemistry, 2009, No. 1, p. 27, (citable as 10.1134/S1070428009010047). It is known that potassium cations (K⁺) and sodium cations (Na⁺) can lodge in the cavity of corresponding crown compounds. It has also been discovered that dissolving electroneutral alkali metals in aromatic hydrocarbons and alkylamines in the presence of crown ethers results in the preparation of corresponding nanoparticles of alkali metal anions, see id. These polihomometallic anions, Na₇⁻ and K₇⁻, have much basicity, and are apparently able to transfer that basicity to organic solvents. This basicity is useful for eliminating HCl when preparing ferrocene according to the present method.

In the present method, the K₇⁻ nanoparticle is prepared by dissolving potassium in the organic solvent. Because alkali metals have a cubic crystalline structure, the elementary cell contains eight atoms of the metal. In such an elementary cell, many of the atoms have an electropositive charge. The crown ether accepts one of the atoms into the crown ether cavity, and the other seven atoms stay with electrons outside the cavity. Thus, the resulting complex has contents [CWK+]K₇⁻. The crown ether destroys the metal cells, thereby producing a polyhomometal anion.

The prepared metallocenes have been tested for usefulness as anti-NOx emission reagents in internal combustion engines. Chemical sensors indicate significant reduction in the concentration of NOx in the exhaust gases. For example, a cobalt containing metallocene provided a reduction of 80-85% of NOx emissions. Methyl substituted ferrocene provided a 95-98% reduction in NOx emissions.

### EXAMPLES

### Direct preparation of bis(cyclopentadienil) iron from FeCl₃

16.3 grams (0.1 mol) of FeCl₃ was added to a mixture of 160 ml of diethylamine containing 1.8 grams (0.005 mole) of dibenzo-18-crown-6 and 3.9 grams (0.1 mole) potassium under a dry nitrogen atmosphere. At a temperature range of 25-35° C., 19.5 grams of cyclopentadiene was added by drop and the mixture stirred for about 3.5 hours, then the diethylamine was removed by distillation. The dry residue was extracted with 550 ml of a gas condensate fraction (b.p. 35-60° C.). Three-fourths of the gas condensate was removed at a pressure of about 15-20 mm Hg and the brown crystalline residue of Fe(C₅H₅)₂ recrystallized from the remaining gas condensate fraction. The yield was 17.8 grams (95.7%) of product.

Using the same method, mixing 25 grams (0.38 mole) of cyclopentadiene and 21.5 grams (0.13 mole) of ferric chloride in 150 ml of diethylamine containing 2.1 grams (0.006 mole) of dibenzo-18-crown-6 and 5.07 g (0.13 mole) potassium or sodium (0.13 mole) resulted in the preparation of 30.5 grams (96.6%) of ferrocene.

Using the same method, 16.7 grams (0.26 mole) of cyclopentadiene and 15.2 grams (0.095 mole) of ferric chloride were added to 160 ml of diethylamine containing 1.7 grams (0.0047 mole) of dibenzo-18-crown-6 and 3.9 grams (0.1 mole) of potassium. The product was 17.8 grams of ferrocene (75.6%).

Using the same method, 24 grams (0.3 mole) of methylcyclopentadiene and 16.25 grams (0.1 mole) of ferric chloride were added to 150 ml of diethylamine containing 2.1 grams (0.006 mole) dibenzo-18-crown-6 and 3.9 grams (0.1 mole) of potassium to prepare 25.7 grams (90.9%) of bis-(dimethylcyclopentadienil) iron. The product was separated as a dark orange-red liquid boiling at 238-240° C. at a pressure of 760 mm.

### Preparation of bis-(cyclopentadienil) cobalt

CoBr₂ was prepared by adding 0.1 mole of bromine to 0.2 mole of cobalt powder suspended in 150 ml of ethylene glycol dimethyl ether. After adding 150 ml of diethylamine and 0.2 mole cyclopentadiene, the mixture was stirred for about 4 hours. 400 ml of gas condensate fraction (b.p. 35-60° C.) was added and the mixture filtered. The filtrate was vacuum stripped (15-20 mm Hg) and a dark-red crystalline residue of Co(C₅H₅)₂ was refined at 1.5 mm. Hg and 60-110° C. to yield 13.1 grams of dark-red crystalline bis-(cyclopentadienil) cobalt.

### Increased Octane

To a motor fuel of straight run gasoline with an initial boiling point of 35° C. and an ending boiling point of 205° C. was added bis-(methylcyclopentadienil) iron (VI) in an amount so that there was 0.02 grams of iron (present as dimethylferrocene (VI)) per liter of fuel. This resulting liquid hydrocarbon fuel possesses superior antiknock qualities. The octane rating of the gasoline increased from 62 up to 78.

### NOx Reduction

To a motor fuel of a diesel fraction with an initial boiling point of 340° C. and an ending boiling point of 360° C. was added sufficient dicyclopentadienil cobalt so that there was 0.04 grams of cobalt (present as dicyclopentadienil) per liter of fuel. After combustion of the diesel fuel in a diesel motor without the additive, the NOₓ emission was 124 mg/m³. After adding the additive, the NOₓ emission was 7 mg/m³. NOₓ emissions were reduced by approximately 95%. The level of NOₓ emissions was determined by a chemical sensor.

To a motor fuel of a diesel fraction with an initial boiling point of 340° C. and ending boiling point of 360° C. was added sufficient bis-(methylcyclopentadienil) iron (VI) so that there was 0.03 grams of iron (present as bis-(methylcyclopentadienil) iron) per liter of the fuel. Combustion resulted in a 90% reduction of NOₓ emissions. Experimental results indicate that mono- and dimethylsubstituted ferrocenes may be more effective additives for increasing the octane rating of motor fuels and do not give some sediments. Also, adding 0.0001-0.0005% of acetic acid to the motor fuel helps prevent sediment formation in the engine.

Experimental data indicates that a metallocene mixture increases the NOₓ reduction. Table 1 shows the percentage reduction of a 1:1, 2:1 and 1:2 mixture of ferrocene and nickelocene.

TABLE 1

| | Mole ratio of | NOₓ | Seperately taken | NOₓ |
|---|---|---|---|---|
| Metallocene | metallocenes in | reducing | metallocene, | reducing |
| Mixture | mixture | ability, % | 0.08% | ability, % |
| Ferrocene + | 1:1 | 76 | Ferrocene | 69 |
| nickelocene | | | | |
| Ferrocene + | 2:1 | 95 | Nickelocene | 72 |
| nickelocene | | | | |
| Ferrocene + | 1:2 | 82 | | |
| nickelocene | | | | |

In this example, 0.8 g (0.08%) of the three metallocene mixture (1:1, 2:1, and 1:2 ferrocene to nickelocene) was added to one kilogram of diesel fuel. As Table 1 shows, the NOₓ reduction was greatest using the 2:1 ferrocene to nickelocene mixture, but all three of the mixtures were more effective than either metallocene alone.

The present method produces metallocenes in a one-step process using relatively inexpensive materials compared to the prior methods. Thus, the present method has several advantages over the prior art. It will be obvious to those of skill in the art that the method described in this specification may be modified to produce different embodiments of the present method. Although embodiments of the invention have been illustrated and described, various modifications and changes may be made by those skilled in the art without departing from the spirit and scope of the invention. Besides, the present method allow to produce metallocene in industrial scale.

1. A method of producing ferrocene by:
adding a predetermined amount of iron chloride (FeCl₃) to a solution containing predetermined amounts of diethylamine and cyclopentadien, a crown ether or a cryptand, and an alkali metal at a predetermined temperature under a dry nitrogen atmosphere;
stirring and boiling the mixture for a predetermined time;
distilling the diethylamine out of the mixture by boiling;
quantitatively extracting ferrocene from the reaction mixture using a hydrocarbon condensate fraction having a high selectivity for metallocenes; and
vacuum stripping the extract to crystallize ferrocene from the hydrocarbon condensate solution

2. The method of claim 1 wherein the crown ether or cryptand includes an alkali metal cation in its cavity, forming polyhomoalkali metal anion having high basity

3. The method of claim 1 wherein dissolving the crown ether or cryptand and the alkali metal in diethylamine reduces the FeCl₃ to Fe(II) to allow direct preparation of ferrocene.

4. The method of claim 2 wherein dissolving the alkali metal in dialkylamines in presence of crown ethers or cryptands forms a mixture of polyhomometallic anions having the formula [CWM⁺]Mₙ⁻ where M is an alkali metal and CW is a crown ether or a cryptand.

5. The method of claim 4 wherein the crown ether is selected from the group consisting of 15-crown-5; benzo-15-crown-5, dibenzo-18-crown-6, cryptand [2,2,2], cryptand [2,2,1], and di-nitrogen containing crown ethers, and polynitrogen containing crown ethers.

6. The method of claim 4 wherein the crown ether is selected from the group consisting of crown compounds having 15-member macrocyclic rings that form a complex [CWNa⁺]Na₇⁻; crown compounds having 18-member polyether rings that form a complex [CWK⁺]K₇⁻; and two- and polynitrogencontaining crown compounds having 15- and 16-member macrocyclic ring that form iron, nickel and cobalt complexes [CWM⁺]Mₙ⁻ with different number of metal atom in polyhomometal anion Mₙ⁻ (n=2-6).

7. The method according to claim 4 wherein the polyhomometalic anions increase the basity of the dialkylamines.

8. The method according to claim 6 wherein the crown ether and alkali metal dissolved in the dialkylamine form supramolecular complexes.

9. The method according to claim 1 wherein the predetermined amount of the crown ether or the cryptand is in the range of 0.005-0.006 mole per mole of iron chloride.

10. A method for producing a predetermined organometallic compounds of cyclopentadien having the structure: 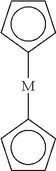
where M is a metal selected from the group consisting of titanium, zirconium, hafnium, vanadium, chromium, molybdenum, tungsten, manganese, iron, ruthenium, osmium, cobalt, rhodium, and nickel, the method comprising the steps of:
adding a predetermined amount of metal halide to a solution containing predetermined amounts of diethylamine, a predetermined crown ether, and a group I metal at a predetermined temperature under a dry nitrogen atmosphere;
stirring and boiling the mixture for a predetermined time;
distilling the diethylamine out from the reaction mixture;
adding a predetermined amount of a hydrocarbon condensate mixture having a boiling point in a predetermined range for quantitatively extracting the metallocene from a dry residue of the reaction mixture;
vacuum stripping the extract to crystallize the organometallic compound from the gas condensate solution.

11. A solvent for extracting a metallocene from a solution comprising a gas condensate fraction having a boiling point in the range of about 35-60° C.

12. A method of increasing the octane rating of a motor fuel comprising the step of adding a predetermined amount of a predetermined metallocene to the motor fuel prior to combustion.

13. A method of reducing NOₓ emissions generated during combustion of a fuel comprising the step of adding a predetermined amount of a predetermined metallocene to the fuel prior to combustion.

14. The method of claim 13 wherein the predetermined metallocene is a mixture of ferrocene and nickelocene.

15. The method of claim 13 wherein the predetermined metallocene is a mixture of ferrocene and nickelocene having a mole ratio of 2:1 ferrocene to nickelocene.
